(19) United States
(12) Patent Application Publication
(10) Pub. No.: US 2005/0183777 A1
(43) Pub. Date: Aug. 25, 2005

(54) Valve, especially a damping valve for a vibration damper

(75) Inventors: Peter Wirth, Schonungen (DE); Wilhelm Broocks, Kurnach (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/059,149

(22) Filed: Feb. 15, 2005

(30) Foreign Application Priority Data
Feb. 21, 2004 (DE) 10 2004 008 648.6

(51) Int. Cl. F16K 15/08

(52) U.S. Cl. 137/516.15

(57) ABSTRACT

A damping valve for a vibration damper includes a valve body, which has at least one flow channel with an inlet and outlet, through which a working medium flows from one side to the other side of the valve body, where the inlet and/or the outlet has a cross section which is larger than that of the flow channel. The inlet and/or the outlet has a flow deflection profile, in which a vortex flow is produced, the flow filaments of which form a fluid cushion for the working medium.

### BACKGROUND OF THE INVENTION

1. Field of the Invention

The invention pertains to a damping valve for a vibration damper, including a valve body having a flow channel through which a working medium can flow from one side to the other side of the valve body, the channel having an inlet and an outlet, at least one of the inlet and outlet having a cross-section which is larger than the cross-section of the channel.

2. Description of the Related Art

A working medium flowing through a valve is subjected to a flow resistance which is determined by, among other things, the geometry of a flow channel. Unfavorable flow conditions in a flow channel can generate noise, which it may not be possible to tolerate in certain practical applications. The flow channels of damping valves are therefore provided with special shapes. U.S. Pat. No. 6,401,755 describes a damping valve for a vibration damper, where the damping valve has a funnel-shaped inlet to and/or outlet from the flow channel. The funnel shape occupies a comparatively large amount of space, which is often not available in the case of a damping valve for a vibration damper, because otherwise the walls in the area of the damping valve would become too thin. The damping valve in U.S. Pat. No. 6,401,755 consists of a sintered body, which can be made even into complicated shapes with comparatively little effort.

U.S. Pat. No. 6,018,868 and DE 198 46 460 A1 describe a piston which is made as a precision-stamped part. Stamping necessarily leads to the formation of radii at the transitions to the flow channels around the elevated valve seating surfaces; these radii are highly dependent on manufacturing tolerances. As a result, noise can be produced, and the lifting behavior of the valve disk can be imprecise. The attempt has been made to correct these defects by lightly regrinding the valve seating surfaces, but this manufacturing operation is expensive and requires a subsequent burr-removal step. The burrs on the pistons are removed mechanically by a vibratory grinding process. The pistons are place in a vibrating container together with abrasive bodies and a grinding fluid and kept in constant motion. The burrs are thus knocked off. This process, however, is not especially advantageous with respect to the valve seating surfaces, the surface quality of which can be impaired.

As an alternative to grinding, a pressing of the valve seating surfaces is conceivable, but if the tolerances are unfavorable, undefined geometries can be present in the flow path leading from the flow channels to the valve seating surfaces.

### SUMMARY OF THE INVENTION

The task of the present invention is to improve the flow channel inside the valve body in such a way that the generation of noise is minimized.

According to the invention, the inlet and/or the outlet has a flow deflection profile in which a vortex flow is produced, the flow filaments of which form a fluid cushion for the working medium.

The fluid cushion acts almost as a bearing for the flow and ensures a nomturbulent or at least low-turbulence flow, so that flow noise at the valve is minimized.

In a further advantageous elaboration, the flow deflection profile is designed as a stepped profile. A stepped profile can also be produced with high precision in valve bodies made by stamping.

The transition between the length of the step and its height can also be rounded to help achieve the desired vortex flow.

Experiments have shown that a stepped profile in which the ratio of the height of the step to its width is in the range of 1:1 to 1:6 produces especially favorable flow conditions.

Alternatively, the flow deflection profile can be formed by a vortex chamber, which is formed in the wall of the flow channel.

To give the flow an effective twist inside the flow chamber, the floor of the flow chamber is rounded in the flow direction.

The flow channels themselves can be produced with satisfactory precision. It is difficult, however, to produce the transition from the flow channel to the seating surface for the valve disk. For this reason, the outlet is designed to merge into the seating surface for the valve disk, and the flow deflection profile is provided upstream of the seating surface. The worst noise is produced at the valve seating surface, because an undefined flow can cause the valve disk to rise abruptly under certain conditions.

In another advantageous embodiment, a processing allowance for the stamping operation at the valve seating surface is included in the distance which determines the height of the step, i.e., the difference between the level of the forward edge and that of the rear edge of the flow deflection profile. Instead of a grinding operation to produce a defined valve seating surface, a much lower-cost stamping operation can thus be performed, which does not require any finishing work on the valve seating surface.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an example of the application of a valve body in a vibration damper;

FIG. 2 shows an enlarged view of the valve body in the form of a piston valve according to FIG. 1; and

FIGS. 3 and 4 show detailed views of the flow channel in the valve body.

### DETAILED DESCRIPTION OF THE PRESENTLY PREFERRED EMBODIMENTS

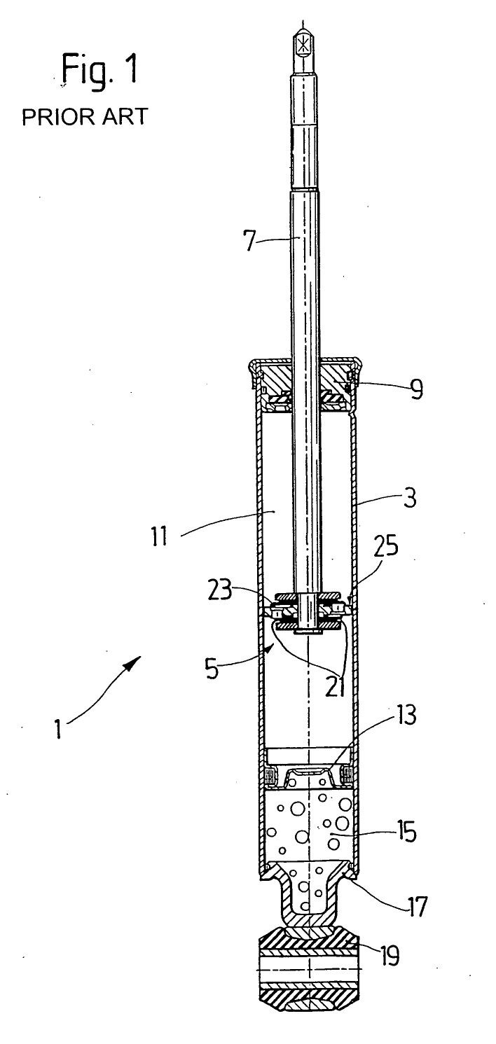

FIG. 1 shows by way of example a piston-cylinder assembly 1 in the form of a single-tube vibration damper. In principle, the invention can also be applied to other piston-cylinder assemblies.

The single-tube vibration damper 1 consists essentially of a pressure tube 3, in which a valve body in the form of a piston 5 is mounted on a piston rod 7 with freedom of axial movement. At the outlet end of the piston rod 7, a piston rod guide 9 closes off a damping medium-filled working space 11, which is separated by a separating piston 13 from a gas space 15, which has a bottom piece 17 with an eye 19 at the end.

When the piston rod moves, damping medium is displaced through damping valves 21 in the piston 5, which are formed by valve disks 23. A piston ring 25, which extends around the circumference of the piston 5, prevents the medium from flowing around the sides of the piston.

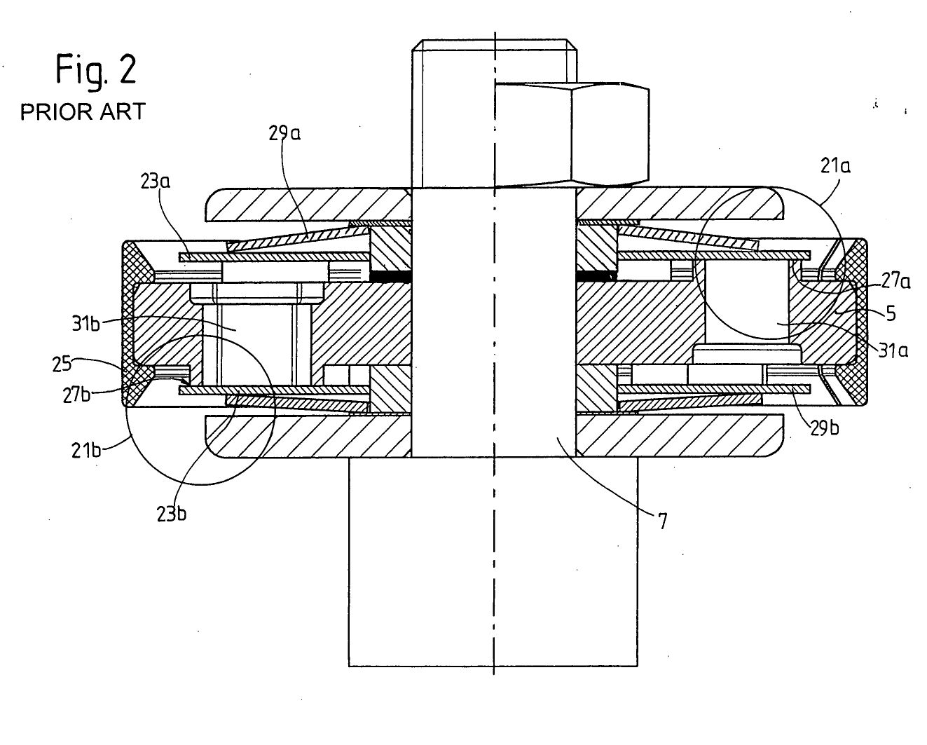

FIG. 2 shows a detailed view of the piston 5 in the form of a valve body. Damping valves 21a; 21b with valve disks 23a, 23b are used for both flow directions. The valve disks are pretensioned onto the valve seating surfaces 27a; 27b. The valve disks 23a; 23b are pretensioned onto the valve seating surfaces by at least one additional spring 29a; 29b. It is also possible to eliminate a separate spring and to use an elastic valve disk. The valve body 5 consists of a pressed part, the valve seating surfaces of which are calibrated by the stamping operation.

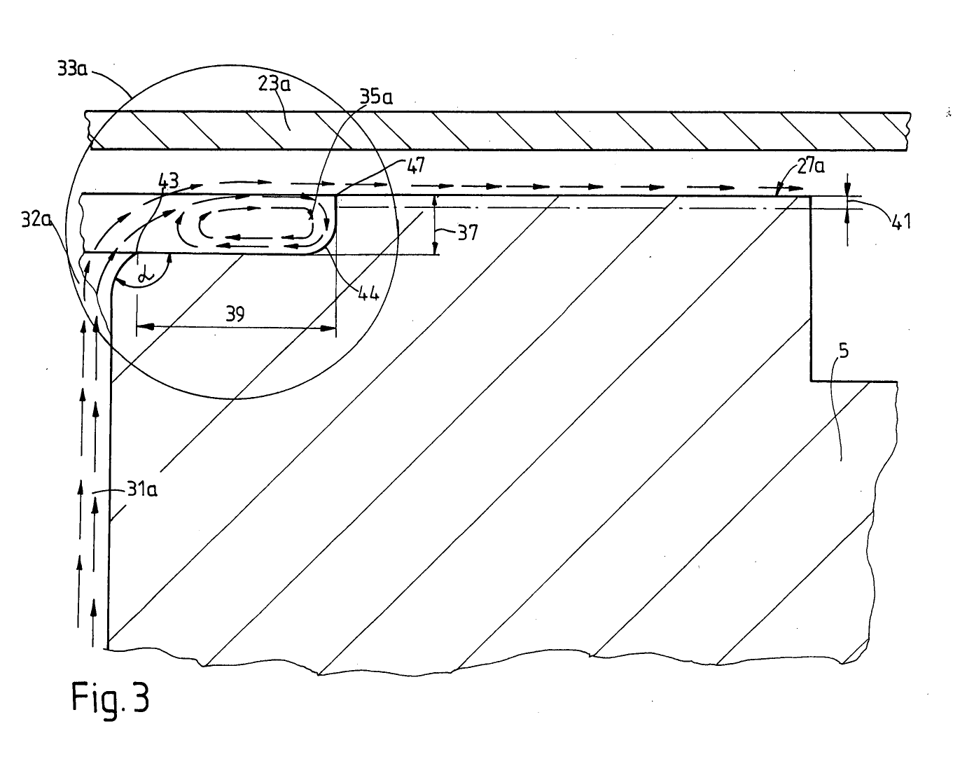

FIG. 3 shows a section of the valve body 5 according to FIG. 2 in the area of a flow channel 31a or 31b and the transition to the valve seating surface 27a. The arrows symbolize the direction of the flow of the working medium passing through the flow channel 31a. An outlet 32a of the flow channel 31a has a flow deflection profile 33a, which is intended to generate a vortex flow, so that the flow filaments at the flow deflection profile 33a create a fluid cushion 35a for the working medium. The rear edge 47 of the flow deflection profile 33a at the outlet 32a immediately precedes the valve seating surface 27a. In this design variant, the flow deflection profile is designed as a stepped profile. An angle α between the profile of the outlet 32a and the flow deflection profile 33a is selected so that the flow breaks off at the forward edge 43, and some of the volume pours out of the flow channel into the flow deflection profile. A vortex flow thus forms. Experiments have shown that the stepped profile is especially effective when the ratio between the height 37 of the step and its length 39 is in the range of 1:1 to 1:6. Especially good results have been obtained with a step ratio of 1:2 to 1:4. This range of variation allows the possibility of reserving manufacturing tolerance 41 for the stamping operation, so that tolerances in the height of the valve body 6 can be compensated. The stamping operation also makes it possible to maintain the stepped profile very precisely. A rounded transition 44 between the step length 39 and the height 37 improves the efficiency of vortex formation.

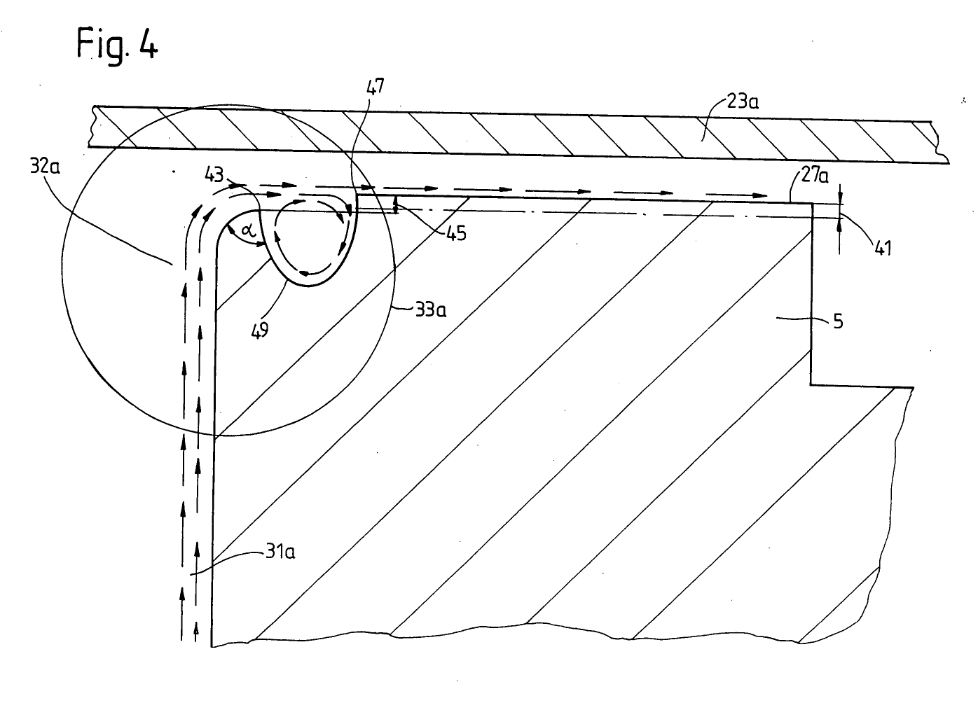

FIG. 4 is intended to show that flow deflection profiles 33a of other types are also conceivable. In the outlet 32a, a vortex chamber is formed. The front height of the edge 43 of the chamber, i.e., the edge which the flow reaches first, has an offset 45 versus the rear edge 47. The forward edge forms in turn an angle α to the outlet, which angle breaks off some of the flow at the outlet 32a and allows it to enter the vortex chamber. The vortex chamber has a bottom 49 which is rounded in the flow direction, so that a vortex is formed. The rest of the volume of the working medium slides along the top of this vortex.

The flow deflection profile 33a can be considered a microprofile in comparison with the size of the outlet 32a and the cross section of the flow channel 31a. Thus, for example, the length 39 of the step in the variant according to FIG. 3 is approximately 0.3 mm, and the height of the step is approximately 0.1 mm. This allows the possibility of providing a small transition radius or transition bevel at the outlet 32a, leading to the valve seating surface. In conjunction with the use of the flow deflection profile 33a, the flow conditions at the valve seating surface 27a will nevertheless remain very uniform.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A damping valve for a vibration damper, said damping valve comprising a valve body, said valve body comprising at least one flow channel through which a working medium flows through the valve body, each flow channel having an inlet and an outlet, at least one of said inlet and an outlet having a flow deflection profile which produces a vortex flow in said working medium, said vortex flow forming a cushion over which said working medium flows.

2. The damping valve of claim 1 wherein said flow deflection profile comprises a step.

3. The damping valve of claim 2 wherein the step has a height and a length, wherein the ratio of the height to the length is in the range of 1:1 to 1:6.

4. The damping valve of claim 3 wherein the step has a rounded transition between the length and the height.

5. The damping valve of claim 1 wherein the flow deflection profile comprises a vortex chamber formed in a wall of the flow channel.

6. The damping valve of claim 5 wherein the flow deflection profile has a rounded bottom.

7. The damping valve of claim 1 wherein the valve body further comprises a valve seating surface for a valve disk adjacent to said outlet, the flow deflection profile being formed in said outlet immediately preceding said valve seating surface.

8. The damping valve of claim 1 wherein the flow deflection profile has a front edge and a rear edge at different levels, the difference between said levels including a manufacturing tolerance.
